(19) United States
(12) Patent Application Publication
(10) Pub. No.: US 2024/0399720 A1
(43) Pub. Date: Dec. 5, 2024

(54) MULTILAYER STRUCTURE WITH AN IMPROVED HYDROGEN BARRIER

(71) Applicant: Kuraray Co., Ltd., Okayama (JP)

(72) Inventors: Hiroyuki SHIMO, Chiyoda-ku, Tokyo (JP); Yannick GEBOES, Melsele (BE); Naomi WINCKELMANS, Melsele (BE)

(73) Assignee: Kuraray Co., Ltd., Okayama (JP)

(21) Appl. No.: 18/693,927

(22) PCT Filed: Sep. 16, 2022
(86) PCT No.: PCT/JP2022/034680

§ 371 Date: Mar. 20, 2024

(30) Foreign Application Priority Data
Sep. 21, 2021 (JP) 2021-153100

(51) Int. Cl. B32B 27/08; B32B 1/08; B32B 7/02; B32B 27/30; B32B 27/32; B32B 27/34; F17C 1/16; H01M 8/04082

(52) U.S. Cl. CPC B32B 27/08; B32B 1/08; B32B 7/02; B32B 27/306; B32B 27/32; B32B 27/34; F17C 1/16; H01M 8/04216; B32B 2250/03; B32B 2250/24; B32B 2307/7246; B32B 2307/7376; B32B 2439/40; B32B 2597/00; F17C 2203/0604; F17C 2203/0621; F17C 2203/066; F17C 2203/0675; F17C 2221/012; F17C 2270/0168; F17C 2270/0184; H01M 2250/20

(57) ABSTRACT

The present invention relates to a multilayer structure for storing or transporting a gas comprising hydrogen, wherein the multilayer structure comprises at least three layers comprising an inner layer comprising at least one first polymer, a middle layer comprising ethylene-vinyl alcohol copolymer, and an outer layer comprising at least one second polymer, and wherein the water-vapour transmission rate of the inner layer is lower than that of the outer layer. The multilayer structure has excellent hydrogen gas barrier properties. Therefore, the multilayer structure is suitable for a hydrogen storage vessel and a hydrogen transportation pipe.

### TECHNICAL FIELD

The present invention relates to a multilayer structure with improved hydrogen barrier properties as well as means for hydrogen storage and transport comprising the same.

### BACKGROUND ART

Composite hydrogen tanks as used today generally contain a monolayer liner made from an impact modified polyamide (PA) or a polyolefin. However, polyolefin liners and even PA liners face the issue that they may show insufficient barrier properties with respect to hydrogen gas.

Ethylene-vinyl alcohol copolymer (EVOH) is known as an excellent barrier material for different gases, including hydrogen gas. JP 2016-135833A (PTL 1) has described a monolayer liner for a pressure vessel made of a resin composition containing EVOH, an acid-modified ethylene-α-olefin copolymer and glycerin. It is described that the monolayer liner is formed by injection molding and is excellent in hydrogen barrier properties. A carbon fiber is wound around the surface of the liner and fixed with an epoxy resin adhesive to form a reinforcing layer before filling with high pressure hydrogen. However, since an EVOH resin is hard, the monolayer liner has insufficient shock resistance even when it contains a rubber and/or a plasticizer.

Consequently, multilayer structures including a layer comprising EVOH have already been described. To this end, US 2014/0008373 A1 (PTL 2) describes a multilayer structure comprising a PA layer as inner layer, an EVOH layer as middle layer and a high-density polyethylene (HDPE) layer as outer layer. The HDPE outside layer is described as an outside-to-inside moisture barrier as the outside environment generally has a much higher moisture level than the hydrogen gas, which is generally close to or down to 0% RH.

Such moisture barrier layers facing the outside environment are often used as it is known that the gas barrier properties of EVOH is dependent on the level of humidity. For example, it is described in Polymer Testing, Volume 93, January 2021, 106979 (NPL 1) that the nitrogen barrier properties of EVOH as a function of the relative humidity (RH) reaches a maximum value at around 30-35% RH and then rapidly decreases as the RH increases.

U.S. Pat. No. 6,033,749 A (PTL 3) has described a fuel tank for gasoline, comprising a multilayer structure comprising an EVOH layer with inner and outer HDPE layers via adhesive resin layers, wherein a ratio (I/O) is less than about 40/60, wherein I is the total thickness of the layers positioned inside the EVOH layer and 0 is the total thickness of the layers positioned outside the EVOH layer. There is described that shifting the EVOH layer to the inside improves gasoline barrier properties and impact resistance in comparison with the case where the EVOH layer is positioned at the center.

### CITATION LIST

### Patent Literature

### [PTL 1]

JP 2016-135833 A

### [PTL 2]

US 2014/0008373 A1

### [PTL 3]

U.S. Pat. No. 6,033,749 A

### Non Patent Literature

### [NPL 1]

Polymer Testing, Volume 93, January 2021, 106979

### SUMMARY OF INVENTION

### Technical Problem

To solve the above problems, an objective of the present invention is to provide a multilayer structure having excellent hydrogen gas barrier properties. Another objective is to provide a hydrogen storage vessel and a hydrogen transportation pipe comprising the multilayer structure described above.

### Solution to Problem

The above problems can be solved by providing a multilayer structure for storing or transporting a gas comprising hydrogen, wherein the multilayer structure comprises at least three layers comprising
a. an inner layer comprising at least one first polymer,
b. a middle layer comprising ethylene-vinyl alcohol copolymer, and
c. an outer layer comprising at least one second polymer, and wherein the water-vapour transmission rate measured at 38° C. and 90% RH according to ISO15106-2:2003 of the inner layer is lower than the water-vapour transmission rate measured at 38° C. and 90% RH according to ISO15106-2:2003 of the outer layer.

### Advantageous Effects of Invention

A multilayer structure of the present invention is excellent in hydrogen gas barrier properties. Hydrogen gas barrier properties can be improved by adjusting water-vapour transmission rates of the inner layer and the outer layer. Therefore, a hydrogen storage vessel and a hydrogen transportation pipe comprising the multilayer structure described above are also excellent in hydrogen gas barrier properties.

### DESCRIPTION OF EMBODIMENTS

As described in Polymer Testing (NPL 1), it is well-known that EVOH has excellent gas barrier properties. Furthermore, as shown in FIG. 10 in NPL 1, that the nitrogen barrier properties of EVOH as a function of the relative humidity (RH) reaches a maximum value at around 30-35% RH and then rapidly decreases as the RH increases. At such higher levels of RH, the water molecules are believed to act as a plasticizer and weaken the inter- and intramolecular hydrogen bonds which in turn leads to an increase in the chain mobility, making it easier for the nitrogen molecules to permeate and thus, to lower the barrier effect of the EVOH. In addition, FIG. 10 shows that as an ethylene content decreases, moisture absorption prominently impairs nitrogen gas barrier properties.

Surprisingly, the current inventors have now found that the gas barrier properties of EVOH regarding hydrogen gas show a different behavior. Unexpectedly, the hydrogen barrier property of EVOH reaches a maximum at much higher levels of around 75% RH with a strong decrease of the hydrogen barrier properties towards lower moisture levels. In other words, we have found that hydrogen gas barrier properties are improved in EVOH having a higher water content due to an elevated relative humidity.

It is, therefore, preferable that a water content of the middle layer in the multilayer structure of the present invention is 1.1 mass % or more and 4 mass % or less. Thus, hydrogen gas barrier properties of the middle layer are improved. It has been believed that as a water content of EVOH increases, hydrogen bonds between polymer chains in EVOH are so weakened that mobility of the polymer chains increase, leading to deterioration of barrier properties against a nonpolar molecule such as gases including oxygen gas, nitrogen gas and carbon dioxide gas and gasoline. However, overturning the common sense, it has been found that hydrogen gas barrier properties are most improved in a state containing a certain level of water or more. A water content of the middle layer is more preferably 1.2 mass % or more, further preferably 1.3 mass % or more. Meanwhile, if the water content is excessively high, barrier properties may be deteriorated, and thus the water content is more preferably 3 mass % or less, further preferably 2.5 mass % or less.

Based on these surprising findings, the object of the present invention was the provision of a multilayer structure with improved hydrogen barrier properties. A further objective of the present invention is to provide a multilayer structure exhibiting further improved mechanical strength and recyclability. These and other problems have been solved by the present invention.

In a first aspect, the present invention concerns a multilayer structure for storing or transporting a gas comprising hydrogen, wherein the multilayer structure comprises at least three layers comprising
a. an inner layer comprising at least one first polymer
b. a middle layer comprising ethylene-vinyl alcohol copolymer (EVOH), and
c. an outer layer comprising at least one second polymer, and wherein the water-vapour transmission rate measured at 38° C. and 90% RH according to ISO15106-2:2003 of the inner layer is lower than the water-vapour transmission rate measured at 38° C. and 90% RH according to ISO15106-2:2003 of the outer layer.

Thus, unlike the multilayer structure described in US 2014/0008373 A1 (PTL 2), the multilayer structure of the present invention has a higher water-barrier on the side facing the hydrogen-containing gas space than to the outside environment. This allows for the EVOH layer contained within the multilayer structure, to be subjected to a higher level of RH and thus, allowing an improved hydrogen gas barrier.

The water vapour transmission rates (WVTR) of the inner and the outer layer are measured as separate monolayers at 38° C. and 90% RH according to ISO15106-2:2003 using “MOCON PERMATRAN W3/33” from AMETEK MOCON.

The WVTR ratio, defined as WVTR of the outer layer divided by the WVTR of the inner layer is above 1.0. Preferably, the WVTR ratio is above 1.5, more preferably above 2.0, further more preferably above 2.5, most preferably above 5.0.

The EVOH in the middle layer comprises ethylene and vinyl alcohol units as principal structural units. It may include one type or a plurality of types of other structural units in addition to the ethylene unit and the vinyl alcohol unit. However, a content of the other structural units described above is preferably 10 mol % or less, more preferably 5 mol % or less, further preferably 2 mol % or less, and most preferably, the other structural units are substantially absent.

EVOH is usually obtained by co-polymerization of ethylene and vinyl acetate, followed by saponification process of the resultant ethylene-vinyl acetate copolymer.

The lower limit of the content of ethylene units, i.e. the proportion of the number of ethylene units relative to the total number of monomer units in EVOH, is preferably 20 mol %, more preferably 22 mol %. On the other hand, the upper limit of the content of ethylene units is preferably 70 mol %, more preferably 60 mol %, still more preferably 55 mol %, and particularly preferably 50 mol %. Also preferably, the ethylene content is between 20 and 60 mol %, more preferably between 20 and 50 mol %, most preferably between 20 and 35 mol %.

For achieving extremely excellent hydrogen gas barrier properties, an ethylene content of EVOH is preferably 20 mol % or more and 30 mol % or less. It is more preferably 28 mol % or less, further preferably 26 mol % or less. It has been generally believed that when EVOH having a low ethylene content is used at a high humidity, a water content increases and thus hydrogen bonds between polymer chains are so weakened that mobility of the polymer chains increases, leading to deterioration of barrier properties. However, it has been found that barrier properties against hydrogen gas are most improved in a state containing a certain level of water or more, and therefore, it is optimal in the light of hydrogen gas barrier properties that EVOH having a low ethylene content is used in a water-containing state.

Preferably, the lower limit of the saponification degree of the EVOH, i.e. the proportion of the number of vinyl alcohol units relative to the total number of vinyl alcohol units and vinyl acetate units in the EVOH, is preferably 80 mol %, more preferably 95 mol %, particularly preferably 99 mol %, and most preferably 99.9 mol %.

The EVOH layer preferably contains a compound such as an acid and a metal ion in the light of thermal stability and adjustment of viscosity. Examples of this compound include alkali metal salts, carboxylic acids, phosphoric acid compounds and boron compounds, and specific examples are as follows. Here, these compounds can be used as a premix with EVOH.

In the light of thermal stability and adjustment of viscosity, the middle layer of the present invention preferably contains a phosphoric acid compound, alkali metal ion, bivalent metal ion, a boron compound or a carboxylic acid. With a metal salt being contained, the metal salt forms a hydrate which may suitably maintain a water content of the middle layer. Furthermore, with a boron compound being contained, impact resistance may be improved.

The middle layer preferably contains a phosphoric acid compound. A phosphoric acid compound prevents generation of defects such as streaks and fish eyes while improving long run property. Examples of the phosphoric acid compound include salts of a phosphoric acid such as phosphate salts and phosphite salts. The phosphate salt can be any form of a monobasic phosphate salt, a dibasic phosphate salt and a tribasic phosphate salt. There are also no restrictions to a cationic species for a phosphoric acid salt, and salts of an alkali metal and an alkaline earth metal are preferable. Among these, phosphate-ion containing compounds such as sodium dihydrogen phosphate, potassium dihydrogen phosphate, disodium hydrogen phosphate and dipotassium hydrogen phosphate are more preferable, and sodium dihydrogen phosphate and dipotassium hydrogen phosphate are further preferable. When the middle layer contains a phosphate-ion containing compound as a phosphoric acid compound, the lower limit of a phosphate ion content is preferably 5 ppm, more preferably 10 ppm, further preferably 20 ppm, particularly preferably 30 ppm. The upper limit of a phosphoric acid compound content to the middle layer is preferably 200 ppm, more preferably 150 ppm, further preferably 100 ppm. With a phosphoric acid compound being the above lower limit or more or the above upper limit or less, thermal stability is improved and generation of gel-like particles, coloration and the like during melt molding for a long period can be minimized.

The middle layer preferably contains alkali metal ion. The alkali metal ion can be one type or a combination of two or more types. Examples of the alkali metal ion include lithium, sodium, potassium, rubidium and cesium ions, and in the light of industrial availability, sodium or potassium ion is preferable. Examples of an alkali metal salt giving alkali metal ion include salts, aliphatic carboxylate aromatic carboxylate salts, carbonate salts, hydrochlorides, nitrate salts, sulfate salts, phosphate salts and metal complexes. Among these, preferred are aliphatic carboxylic acid salts and phosphate salts in the light of availability; specifically, preferred are sodium acetate, potassium acetate, sodium phosphate, potassium phosphate, sodium stearate and potassium stearate. When the middle layer contains alkali metal ion, the lower limit of an alkali metal ion content is preferably 10 ppm, more preferably 100 ppm, further preferably 150 ppm. Meanwhile, the upper limit of an alkali metal ion content is preferably 400 ppm, more preferably 350 ppm. When an alkali metal ion content is the above lower limit or more, interlayer adhesiveness of a multilayer structure obtained tends to be improved. Meanwhile, when a metal ion content is the above upper limit or less, coloration resistance tends to be improved.

The middle layer preferably contains phosphate ion in 5 ppm or more and 200 ppm or less and alkali metal ion in 10 ppm or more and 400 ppm or less.

In some cases, it is preferable that the middle layer contains bivalent metal ion. With bivalent metal ion being contained, for example, thermal degradation of EVOH in recycling a recovered trim is suppressed and generation of gel and particles in a molded article obtained may be suppressed. Examples of bivalent metal ion include beryllium, magnesium, calcium, strontium, barium and zinc ions, and in the light of industrial availability, magnesium, calcium and zinc ions are preferable. Preferable examples of a bivalent metal salt giving bivalent metal ion include carboxylate, carbonate, hydrochloride, nitrate, sulfate, phosphate and metal complexes, preferably carboxylate. A carboxylic acid constituting a carboxylate salt is preferably a carboxylic acid with 1 to 30 carbon atoms, specifically acetic acid, propionic acid, butyric acid, stearic acid, lauric acid, montanic acid, behenic acid, octylic acid, sebacic acid, recinoleic acid, myristic acid, and palmitic acid. Among these, acetic acid and stearic acid are preferable.

The middle layer preferably contains a carboxylic acid. A carboxylic acid prevents coloration of a resin composition and also a molded article and suppresses gelation during melt molding. Examples of the carboxylic acid include formic acid, acetic acid, propionic acid, butyric acid and lactic acid. The carboxylic acid is preferably a carboxylic acid with 4 or less carbon atoms, more preferably acetic acid. When the middle layer contains a carboxylic acid, the lower limit of a carboxylic acid content is preferably 50 ppm, more preferably 80 ppm, further preferably 120 ppm. The upper limit of a carboxylic acid content is preferably 1, 000 ppm, more preferably 500 ppm, further preferably 400 ppm. With a carboxylic acid content being the above lower limit or more, sufficient coloration suppression effect can be achieved and yellowing can be sufficiently suppressed. Meanwhile, with a carboxylic acid content being the above upper limit or less, gelation during melt molding, particularly long-term melt molding is suppressed, giving good appearance of a molded article or the like. Here, more preferably acetic acid and an acetate salt are combined, and further preferably acetic acid and sodium acetate are combined.

The middle layer preferably contains a boron compound, which can prevent torque variation during heating and melting. Examples of the boron compound include, but not limited to, boric acids, borate esters, borate salts, and borohydrides. Specifically, boric acids include orthoboric acid, metaboric and tetraboric acid; borate esters include triethyl borate and trimethyl borate; borate salts include alkali metal salts and alkaline earth metal salts of the above various boric acids and borax. Among these compounds, orthoboric acid (hereinafter, sometimes referred to as simply “boric acid”) is preferable. A content of the boron compound is preferably 50 ppm or more and 400 ppm or less in terms of boron element. With a boron compound content being 50 ppm or more, melt moldability tends to be stable; more preferably, the content is 70 ppm or more, further preferably 100 ppm or more. Meanwhile, with a boron compound content being 400 ppm or less, deterioration in moldability tends to be prevented; more preferably the content is 350 ppm or less, optionally 300 ppm or less.

The middle layer may contain in addition to the aforementioned EVOH additives such as heat stabilizers, ultraviolet ray absorbing agents, antioxidants, plasticizers, antistatic agents, lubricants, colorants and fillers in the range not to impair the object of the present invention. When the middle layer contains such additives other than the additives described above, the amount is preferably no greater than 10% by mass, more preferably no greater than 5% by mass, and particularly preferably no greater than 3% by mass with respect to the total mass of the middle layer.

Suitable antioxidants as used herein are materials which inhibit oxidative degradation or cross-linking of EVOH and include 2,5-di-t-butylhydroquinone, 2,6-di-t-butyl-p-cresol, 4,4′-thiobis-(6-t-butylphenol), 2,2′-methylenebis-(4-methyl-6-t-butylphenol), octadecyl-3-(3′,5′-di-t-butyl-4′-hydroxyphenyl) propionate, 4,4′-thiobis-(6-t-butylphenol), tetrakis(3-(3,5-di-tert-butyl-4-hydroxyphenyl)propionate), 3,3′-bis(3,5-di-tert-butyl-4-hydroxyphenyl)-N,N′-hexamethylenedipropionamide.

Suitable plasticizers include diethyl phthalate, dibutyl phthalate, dioctyl phthalate, wax, liquid paraffin, phosphoric acid esters and the like.

Suitable ultraviolet ray absorbing agents include ethylene-2-cyano-3,3′-diphenyl acrylate, 2-(2′-hydroxy-5′-methylphenyl)benzotriazole, 2-(2′-hydroxy-5′-methylphenyl)benzotriazole, 2-(2′-hydroxy-5′-methylphenyl)benzotriazole, 2-(2′-hydroxy-3′-t-butyl-5′-methylphenyl)5-chlorobenzotriazole, 2-hydroxy-4-methoxybenzophenone, 2,2′-dihydroxy-4-methoxybenzophenone and the like.

Suitable antistatic agents include pentaerythritol monostearate, sorbitan monopalmitate, sulfated polyolefins, polyethylene oxides and the like.

Suitable lubricants include ethylenebis (stearic acid amide), butyl stearate and the like.

Preferably, the middle layer does not contain additional polymer other than EVOH. However, the middle layer can also preferably comprise at least one additional polymer chosen from the list consisting of elastomers, polyolefins, polyesters, polyurethanes and polyamides.

Elastomers useful in the invention can be chosen from thermoplastic styrenic elastomer or an α-olefin copolymer, ethylene-propylene rubber acrylic (EPR), rubber (ACM), acrylonitrile-butadiene rubber (NBR), butadiene rubber (PBD, BR), isoprene rubber (IR), natural rubber (NR), styrene-butadiene rubber (SBR) and styrenic copolymers (SBS, SIS). And preferably thermoplastic styrenic elastomer or an α-olefin copolymer are selected, and more preferably acid modified thermoplastic styrenic elastomer or an α-olefin copolymer.

There are no particular restrictions to a thermoplastic styrenic elastomer, and those known in the art can be used. A thermoplastic styrenic elastomer generally has a styrene monomer polymer block (Hb) to be a hard segment and a conjugate diene compound polymer block or a hydrogenated block thereof (Sb) to be a soft segment. The structure of this thermoplastic styrenic elastomer can be a di-block structure represented by Hb-Sb, a tri-block structure represented by Hb-Sb-Hb or Sb-Hb-Sb, a tetra-block structure represented by Hb-Sb-Hb-Sb, or a polyblock structure in which 5 or more of Hb and Sb in total are linearly bonded.

Examples of an α-olefin copolymer include, but not limited to, ethylene-propylene copolymer (EP), ethylene-butene copolymer (EB), propylene-butylene copolymer (PB) and butylene-ethylene copolymer (BE).

Such elastomer in EVOH is preferably acid modified thermoplastic styrenic elastomer or an α-olefin copolymer, and a mixture of an acid-modified elastomer and an unmodified elastomer.

Herein, acid-modification is conducted by copolymerizing, partly substituting α, β-unsaturated carboxylic acid or its anhydride monomers for monomers constituting an α-olefin copolymer or thermoplastic styrenic elastomer, or alternatively introducing an α, β-unsaturated carboxylic acid or its anhydride to some side chains by, for example, graft reaction such as radical addition. Examples of an α, β-unsaturated carboxylic acid or its anhydride used in the above acid-modification include maleic acid, acrylic acid, itaconic acid, crotonic acid, maleic anhydride and itaconic anhydride. Among these, maleic anhydride can be suitably used.

Among these, the middle layer preferably contains 70 mass % or more and 99 mass % or less of EVOH, 1 mass % or more and 30 mass % or less of an acid-modified ethylene-α-olefin copolymer. A middle layer containing an acid-modified ethylene-α-olefin copolymer allows for providing a multilayer structure excellent in impact resistance. A content of the acid-modified ethylene-α-olefin copolymer is more preferably 2 mass % or more, further preferably 5 mass % or more. Here, a content of EVOH is more preferably 98 mass % or less, further preferably 95 mass % or less. Meanwhile, in the light of gas barrier properties, a content of EVOH is preferably 70 mass % or more, more preferably 80 mass % or more, further preferably 85 mass % or more. Here, a content of the acid-modified ethylene-α-olefin copolymer is preferably 30 mass % or less, more preferably 20 mass % or less, further preferably 15 mass % or less.

The first polymer of the inner layer and the second polymer of the outer layer may have the same or a different chemical composition. In other words, the inner and the outer layer can be made from the same or from different materials, including optional additives. A multilayer structure sandwiched between resins other than EVOH allows for providing a hydrogen storage vessel or a hydrogen transportation pipe resistant to damage by deformation due to pressure change of contents and impact from the outside, or a liner used therefor.

In a first preferred embodiment, the first polymer and the second polymer have the same chemical composition. To allow the water-barrier of the outer layer to be smaller than that of the inner layer, the thickness of the inner layer is preferably higher than the thickness of the outer layer.

In a multilayer structure of the present invention, it is preferable that a ratio (I/O) is 60/40 or more and 99/1 or less, wherein I is the total thickness of the layers positioned inside the middle layer and O is the total thickness of the layers positioned outside the middle layer. In other words, in the multilayer structure, it is preferable that the middle layer is disposed outside the center of the whole layers. As described above, it has been found that EVOH in a water-containing state improves hydrogen gas barrier properties. Generally, in a hydrogen storage vessel, high-pressure hydrogen gas with a relative humidity of about 0% is often filled in the vessel, and therefore, the vessel absorbs moisture from the outside by an influence of a relative humidity of ambient environment. In a hydrogen transportation pipe, an inner relative humidity is also often lower. In such a case, for keeping a high water content of the middle layer in the multilayer structure, it is preferable that the middle layer is disposed outside. The ratio (I/O) is more preferably 70/30 or more, further preferably 75/25 or more, particularly preferably 80/20 or more. Meanwhile, since in some cases an excessively high ratio (I/O) is not suitable in the light of impact resistance, the ratio (I/O) is more preferably 98/2 or less, further preferably 95/5 or less, particularly preferably 90/10 or less. It has been known that for a vessel filled with a hydrophobic content such as gasoline, shifting an EVOH layer to the inside is preferable in the light of barrier properties (for example, see PTL 3), but in contrast, for hydrogen gas, it is preferable that the layer is shifted to the outside.

There are no particular restrictions to a thickness ratio of layers constituting the multilayer structure of the present invention, and it is preferable that a ratio (A/B) is 3/97 or more and 30/70 or less, wherein A is the thickness of the middle layer and B is the whole thickness of the multilayer structure. Being sandwiched between the inner and the outer layers having a certain thickness, the multilayer structure can be excellent in mechanical strength. Furthermore, since the middle layer of the present invention has excellent hydrogen gas barrier properties, even the multilayer structure with a small thickness can have sufficient barrier properties. The ratio (A/B) is more preferably 5/95 or more, more preferably 20/80 or less.

Preferably, the thickness of the outer layer is equal to or below 25 mm, more preferably equal to or below 5 mm and most preferably equal to or below 1 mm. When the multilayer structure is used for a thin liner, the thickness of the outer layer is preferably equal to or below 0.5 mm, more preferably equal to or below 0.4 mm and most preferably equal to or below 0.2 mm. On the other hand, the thickness is preferably equal to or above 0.05 mm, equal to or above 0.1 mm and most preferably equal to or above 0.15 mm. Also preferably, the thickness of the outer layer is from 0.05 mm to 0.15 mm.

Preferably, the thickness of the inner layer is equal to or below mm, more preferably equal to or below 5 mm and most preferably equal to or below 2 mm. When the multilayer structure is used for 20 a thin liner, the thickness of the inner layer is preferably equal to or below 1.0 mm, more preferably equal to or below 0.9 mm and most preferably equal to or below 0.8 mm. On the other hand, the thickness is preferably equal to or above 0.2 mm, and more preferably equal to or above 0.5 mm. Also preferably, the thickness of the inner layer is from 0.3 mm to 0.7 mm.

Preferably, the thickness of the middle layer is equal to or below 10 mm, more preferably equal to or below 5 mm and most preferably equal to or below 1 mm. However, the multilayer structure of the invention provides much improved hydrogen gas barrier properties. It might be possible to choose the EVOH-containing main hydrogen barrier layer with a rather low thickness. Preferably, the thickness of the middle layer is below 0.5 mm, more preferably equal to or below 0.4 mm and most preferably equal to or below 0.2 mm. On the other hand, the thickness is preferably equal to or above 0.05 mm, equal to or above 0.1 mm and most preferably equal to or above 0.2 mm. Also preferably, the thickness of the middle layer is from 0.05 mm to 0.15 mm. With a thickness of the middle layer being within the above range, excellent hydrogen barrier properties and impact resistance can be achieved.

Preferably, the total thickness of the all layers in the multilayer structure is equal to or below 50 mm, more preferably equal to or below 30 mm and most preferably equal to or below 20 mm. When the multilayer structure is used for a thin liner, the thickness of the outer layer is preferably equal to or below 10 mm, more preferably equal to or below 7.5 mm and most preferably equal to or below 5 mm. On the other hand, the thickness is preferably equal to or above 0.3 mm, equal to or above 0.5 mm and most preferably equal to or above 0.7 mm. When more excellent hydrogen gas barrier properties and impact resistance are required, the lower limit can be 0.8 mm or more, 1.0 mm or more.

In order to provide good bonding between the EVOH and the inner and/or the outer layer and to avoid the EVOH layer to separate from the inner and/or outer layer during production or usage, the according to the present invention multilayer structure preferably may comprise at least one bonding layer between the inner layer and the middle layer and/or between the outer layer and the middle layer. Such bonding layers are known in the art and can incorporate some polar functionality to promote compatibility with a polar and material some non-polar functionality to maintain compatibility with the non-polar layer. Examples of useful materials for such bonding layers include anhydride modified polyolefins, e.g. maleic anhydride-grafted polypropylenes and polyethylenes, such as “Bynel 40E529” available from DuPont, “Admer HB030” available from Mitsui Chemicals, Inc, and ethylene polar terpolymers such as “LOTADER” available from Arkema.

Preferably, the thickness of the bonding layer is equal to or below 5 mm, more preferably equal to or below 3 mm and most preferably equal to or below 1 mm. When the multilayer structure is used for a thin liner, the thickness of the bonding layer is preferably equal to or below 0.2 mm, more preferably equal to or below 0.1 mm and most preferably equal to or below 0.075 mm. On the other hand, the thickness is preferably equal to or above 0.01 mm, equal to or above 0.02 mm and most preferably equal to or above 0.04 mm. Also preferably, the thickness of the bonding layer is from 0.03 mm to 0.07 mm.

“Thickness” as used herein shall denote the average thickness of the individual layers after preparation of the multilayer structure.

Also preferably, the multilayer structure does not contain any further layer but consists of
a. an inner layer comprising at least one first polymer
b. a middle layer comprising ethylene-vinyl alcohol copolymer, and
c. an outer layer comprising at least one second polymer.

The first and the second polymer are independently selected from polyamide (PA), polyethylene (PE), especially high-density polyethylene (HDPE) or low-density polyethylene (LDPE), polypropylene (PP), polyvinyl chloride (PVC), polystyrene (PS), “Teflon” (polytetrafluoroethylene), thermoplastic polyurethane (TPU), polyvinylidene fluoride (PVdF), polyvinyl alcohol (PVOH), and ethylene tetrafluoroethylene (ETFE).

The polyamide resin is a polymer having an amide bond and can be obtained by ring-opening polymerization of lactam, polycondensation of aminocarboxylic acid or diamine with dicarboxylic acid, or the like.

Examples of the lactam include ε-caprolactam and ω-laurolactam.

Examples of the aminocarboxylic acid include 6-aminocaproic acid, 11-aminoundecanoic acid, 12-aminododecanoic acid, and paraminomethylbenzoic acid.

Examples of the diamine include tetramethylenediamine, hexamethylenediamine, undecamethylenediamine, dodecamethylenediamine, 2,2,4-trimethylhexamethylenediamine, 2,4,4-trimethylhexamethylenediamine, 5-methylnonamethylenediamine, 1,9-nonanediamine, 2-methyl-1,8-octanediamine, m-xylylenediamine, p-xylylenediamine, 1,3-bis(aminomethyl)cyclohexane, 1,4-bis(aminomethyl)cyclohexane, 1-amino-3-aminomethyl-3,5,5-trimethylcyclohexane, bis(4-aminocyclohexyl)methane, bis(3-methyl-4-aminocyclohexyl)methane, 2,2-bis(4-aminocyclohexyl)propane, bis(aminopropyl)piperazine and aminoethylpiperazine.

The dicarboxylic acid is exemplified by succinic acid, glutaric acid, adipic acid, pimelic acid, suberic acid, azelaic acid, sebacic acid, dodecanedicarboxylic acid, cyclohexanedicarboxylic acid, decalindicarboxylic acid, norbornanedicarboxylic acid, tricyclodecanedicarboxylic acid, pentacyclododecanedicarboxylic acid, isophoronedicarboxylic acid, 3,9-bis(2-carboxyethyl)-2,4,8,10-tetraoxaspiro[5.5]undecane, trimellitic acid, trimesic acid, pyromellitic acid, tricarballylic acid, terephthalic acid, isophthalic acid, phthalic acid, 2-methylterephthalic acid, naphthalenedicarboxylic acid, biphenyldicarboxylic acid and tetraphosphorusdicarboxylic acid.

Examples of specific polyamide resins include aliphatic polyamide resins such as polycaprolactam (nylon 6), polylaurolactam (nylon 12), polyhexamethylenediadipamide (nylon 66), polyhexamethyleneazelamide (nylon 69), polyhexamethylenesebacamide (nylon 610), nylon 46, nylon 6/66, nylon 6/12, and a condensation product of 11-aminoundecanoic acid (nylon 11), aromatic polyamide resins such as polyhexamethyleneisophthalamide (nylon 6IP), m-xylenediamine/adipic acid copolymer (nylon MXD6), m-xylenediamine/adipic acid/isophthalic acid copolymer, and 1,9-nonanediamine/2-methyl-1,8-octanediamine/terephtalic acid copolymer (Nylon 9T). These may be used alone or as a mixture of two or more thereof.

Among these polyamide resins, nylon MXD6 having superior gas barrier properties is especially preferred. With respect to a diamine component of the nylon MXD6, m-xylylenediamine is preferably included in an amount of no less than 70 mol %. Whereas, with respect to a dicarboxylic acid component, adipic acid is preferably included in an amount of no less than 70 mol %. When nylon MXD6 is obtained from the monomer blended as described above, more superior gas barrier properties and mechanical performances can be achieved.

To improve the mechanical properties, the polyamide may optionally be compounded with an elastomer, such as thermoplastic styrenic elastomer or an α-olefin copolymer, acrylic rubber (ACM), acrylonitrile-butadiene rubber (NBR), butadiene rubber (PBD, BR), isoprene rubber (IR), natural rubber (NR). Preferably thermoplastic styrenic elastomer or an α-olefin copolymer. In addition to the improved mechanical properties, the addition of the non-polar elastomer will also reduce the WVTR of such compound.

In order to enhance the compatibility with polyamide, such elastomer in polyamide is preferably acid modified thermoplastic styrenic elastomer or an α-olefin copolymer, and a mixture of an acid-modified elastomer and an unmodified elastomer.

TPU can be obtained from a high molecular polyol, an organic polyisocyanate and optionally, a chain extender and other components. The high molecular polyol is a substance having a plurality of hydroxyl groups. Examples of the high molecular polyol include polyester polyol, polyether polyol, polycarbonate polyol, co-condensates thereof (for example, polyester-ether-polyol). These high molecular polyols may be used either alone of one type, or as a mixture of two types thereof.

Because of the relative high cost of fluorinated polymers compared to non-fluorinated polymers, the first polymer is preferably a non-fluorinated polymer. More preferably, the first polymer is a polyamide or a polyolefin. More preferably, the first polymer is HDPE. Also preferable, the second polymer is a non-fluorinated polymer. Specifically, the second polymer is a polyamide (PA).

The gas used in the present invention contains hydrogen as a main component. A content of hydrogen in the whole gas is preferably 80 vol % or more, more preferably 90 vol % or more, further preferably 95 vol % or more, particularly preferably 99 vol % or more, and the gas may substantially consist of hydrogen. The gas can contain a small amount of moisture, but a relative humidity is preferably 20% or less, more preferably 10% or less, further preferably 5% or less, and particularly preferably, moisture is substantially absent (a relative humidity is 0%). However, other components might also be present in the gas. Such components may include, but are not limited to, from methane, ethane, ethene, ethyne, propane, propene, butane, nitrogen, oxygen, argon, carbon dioxide, carbon monoxide, ammonia and hydrogen sulfide. The gas is handled in a hydrogen storage vessel or a hydrogen transportation pipe of the present invention. For a hydrogen transportation pipe, hydrogen gas containing much moisture may be transported, depending on a place of usage. For example, there would be the case where hydrogen gas as a material for a fuel battery is transported while water as a reaction product is mixed into the gas. When such hydrogen gas containing much moisture is transported, the use of the pipe of the present invention is not very effective.

Preferably, the H₂TR of the multilayer structure is below 15, more preferably below 12.5, even more preferably below 11 and specifically below 10 cm³/(m²·day·atm).

It is preferable in the multilayer structure of the present invention that the first polymer is high-density polyethylene (HDPE). Thus, a resin with a smaller water vapour transmission rate can be disposed in the inner layer side. It is also preferable that the second polymer is polyamide (PA). Thus, a resin with a larger water vapour transmission rate can be disposed in the outer layer side, and impact resistance is improved.

A preferable embodiment of the multilayer structure of the present invention is a multilayer structure, wherein both first polymer and second polymer are a high-density polyethylene (HDPE), and a ratio (I/O) is 60/40 or more and 99/1 or less, wherein I is the total thickness of the layers positioned inside the middle layer and O is the total thickness of the layers positioned outside the middle layer. Disposing the middle layer in the outer side allows a water content of the middle layer to increase. Furthermore, HDPE has a small water vapour transmission rate, and therefore, can suppress variation of a water content of the middle layer. Furthermore, both first polymer and second polymer are made of the same thermally stable resin, allowing recyclability to be improved. Here, when the middle layer contains, in addition to EVOH, certain amounts of phosphate ion, alkali metal ion, bivalent metal ion or a carboxylic acid, recyclability is further improved.

Another embodiment of the multilayer structure of the present invention is a multilayer structure, wherein the first polymer is a high-density polyethylene (HDPE) and the second polymer is polyamide (PA), and a ratio (I/O) is 60/40 or more and 99/1 or less, wherein I is the total thickness of the layers positioned inside the middle layer and O is the total thickness of the layers positioned outside the middle layer. Disposing the middle layer in the outer side allows a water content of the middle layer to increase. With the second polymer being made of polyamide, a water content of the middle layer can be increased in rapid response to a humidity of the ambient environment, and impact resistance is improved.

The method for producing the inventive multilayered structure is not particularly limited as long as the method can favorably laminate and adhere the individual layers, and any of the known methods such as coextrusion, pasting, coating, bonding, and attaching may be employed.

It is preferable that after the multilayer structure of the present invention is produced, the multilayer structure is aged in a high relative humidity environment, to adjust a water content of the middle layer to 1.1 mass % or more and 4 mass % or less before storage or transportation of hydrogen gas. Thus, simultaneously with starting storage e or transportation of hydrogen gas, excellent hydrogen gas barrier properties can be exhibited. There are no particular restrictions to an aging method; for example, the multilayer structure is allowed to stand in a high-temperature high-humidity environment for a certain period.

Another aspect of the present invention concerns a hydrogen storage vessel or a hydrogen transportation pipe comprising or consisting of the multilayer structure as described above.

Yet another aspect of the present invention concerns the use of the multilayer structure as described above in a hydrogen storage tank, as a liner for a hydrogen storage tank, in a hydrogen transportation pipe or as a liner for a hydrogen transportation pipe.

The multilayer structure of the present invention can be used as a hydrogen storage vessel or a hydrogen transportation pipe by itself. However, since hydrogen gas pressure is often elevated in these applications, the multilayer structure of the present invention is used as a liner, whose outside can be covered by a reinforcing material. There are no particular restrictions to a configuration of the reinforcing material, and generally, a reinforcing material made of a high-strength fiber such as carbon fiber and glass fiber is fixed by a curable resin. For example, an example in JP 2016-135833 A (PTL 1) describes that carbon fiber is wound around the periphery of a liner and fixed by an epoxy resin. Since a fibrous reinforcing material tends to have gaps and a highly-polar curable resin such as an epoxy resin generally has a large water vapour transmission rate, the inside of the fibrous reinforcing material layer often has a comparable humidity to the outside air. Therefore, even when such a reinforcing material layer is further fixed to the outer side of the multilayer structure of the present invention, it is not included in the total thickness of the multilayer structure.

A suitable embodiment of the hydrogen storage vessel of the present invention is a hydrogen storage vessel, wherein the first polymer is HDPE and the second polymer is HDPE or PA, and a ratio (I/O) is 60/40 or more and 99/1 or less, wherein I is the total thickness of the layers positioned inside the middle layer and O is the total thickness of the layers positioned outside the middle layer. Disposing the middle layer in the outer side allows a water content of the middle layer to increase. When the second polymer is HDPE, it has a small water vapour transmission rate, and therefore, can suppress variation of a water content of the middle layer. Furthermore, both first polymer and second polymer are made of the same thermally stable resin, allowing recyclability to be improved. When the second polymer is PA, a water content of the middle layer can be increased in rapid response to a humidity of the ambient environment, and impact resistance is improved.

Another suitable embodiment of the hydrogen storage vessel of the present invention is a hydrogen storage vessel, wherein the first polymer is HDPE and the second polymer is PA, and a ratio (A/B) is 3/97 or more and 30/70 or less, wherein A is the thickness of the middle layer and B is the whole thickness of the multilayer structure. With a water vapour transmission rate of the outer layer being larger than a water vapour transmission rate of the inner layer, a water content of the middle layer can be increased. Furthermore, with a ratio (A/B) being within a certain range, mechanical strength and gas barrier properties are well balanced. When the second polymer is polyamide, a water content of the middle layer can be increased in rapid response to a humidity of the ambient environment, and impact resistance is improved.

A suitable embodiment of the hydrogen transportation pipe of the present invention is a hydrogen transportation pipe, wherein the first polymer is HDPE and the second polymer is HDPE or PA, and a ratio (I/O) is 60/40 or more and 99/1 or less, wherein I is the total thickness of the layers positioned inside the middle layer and O is the total thickness of the layers positioned outside the middle layer, and a relative humidity of the gas transported is 20% RH or less. With the middle layer being disposed in the outer side, a water content of the middle layer can be increased, and the effect is more effective when a relative humidity of the gas transported is 20% or less. When the second polymer is HDPE, it has a small water vapour transmission rate, and therefore, can suppress variation of a water content of the middle layer. Furthermore, both first polymer and second polymer are made of the same thermally stable resin, allowing recyclability to be improved. When the second polymer is polyamide, a water content of the middle layer can be increased in rapid response to a humidity of the ambient environment, and impact resistance is improved.

Another suitable embodiment of the hydrogen transportation pipe of the present invention is a hydrogen transportation pipe, wherein the first polymer is HDPE and the second polymer is PA, and a relative humidity of the gas transported is 20% or less. With a water vapour transmission rate of the outer layer being larger than a water vapour transmission rate of the inner layer, a water content of the middle layer can be increased, and the effect is more effective when a relative humidity of the gas transported is 20% or less.

The multilayer structure of the present invention can be used for, but not limited to, various hydrogen storage vessels and hydrogen transportation pipes. Preferably, the multilayer structure is used in a motor vehicle, more preferably a fuel cell electric vehicle (FCEV). A fuel cell electric vehicle is a clean automobile, where an exhaust gas is just water, but a problem is how high-pressure hydrogen gas is handled. Although the multilayer structure of the present invention is made of a resin, it has not only excellent hydrogen gas barrier properties but also excellent impact resistance. Therefore, the multilayer structure of the present invention is suitable as a hydrogen storage vessel or a hydrogen transportation pipe mounted on a fuel cell electric vehicle in the light of placing importance on balance between environmental performance and safety.

### EXAMPLES

### Example 1

A 5-layer flat sheet is prepared on a Collin coextrusion line by cast sheet coextrusion of a high-density polyethylene (HDPE) for the inside and outside layers, adhesive resin (Adh) as bonding layers and pure EVOH for the middle layer of the following thicknesses:

(outside=sweep gas side)HDPE/Adh/EVOH/Adh/HDPE(inside=H₂ gas side):100/50/100/50/700 μm

HDPE: High Density Polyethylene HB111R commercially available from Ineos with a melt index of 6.0 g/10 min (at 190° C., 21.6 kg load), density: 0.945 g/cm³.

Adh: Maleic anhydride modified polyethylene “Admer GT6E” commercially available from Mitsui Chemicals Europe GmbH with a melt index of 1.1 g/10 min (at 190° C., 2.16 kg load), density: 0.92 g/cm³.

EVOH-32: Ethylene-vinyl alcohol copolymer with 32 mol % ethylene content, degree of saponification: 99.9 mol %, melt index: 1.6 g/10 min (at 190° C., 2.16 kg load), density: 1.18 g/cm³. The EVOH contains 100 ppm of acetic acid, 40 ppm of phosphate ion, 150 ppm of sodium ion and 180 ppm (in terms of boron atom) of boric acid.

The water vapour transmission rates (WVTR) of the inner layer (700 μm HDPE) and the outer layer (100 μm HDPE) are measured as separate monolayers at 38° C. and 90% RH according to ISO15106-2:2003 using “MOCON PERMATRAN W3/33” from AMETEK MOCON. Specifically, for the inner and the outer layers used in Examples and Reference examples, a water vapour transmission rate was measured at 38° C. under the conditions of a relative humidity of the water vapour supplying side of 90%, a relative humidity of the carrier gas side of 0%, and a carrier gas flow rate of 50 mL/min.

The multilayer structure after molding was subjected to a humidity adjusting process. In the humidity adjusting process, the inside of the multilayer structure was kept in contact with the air at 20° C. and 0% RH while the outside was kept in contact with the air at 20° C. and 50% RH for 1 month, to adjust humidity. A water content of the middle layer thus humidity-adjusted was measured by a Karl Fischer moisture meter. Specifically, the humidity-adjusted multilayer sheet was cut into a piece with an appropriate size, for which the outer and the inner layers were scraped off using a microtome such that only the middle layer remained. The middle layer obtained was subjected to measurement of a water content. As a result, a water content of the middle layer was 1.4 mass %.

The hydrogen gas transmission rate (H²TR) of this moisture-controlled multilayer sheet is measured according to ISO 15106-2:2003 using a custom temperature-controlled permeation box in which “MOCON” test cells are installed. All measurements are performed at a temperature of 20° C. A customized EasyCal Unit (Umwelttechnik MCZ GmbH) is used to regulate and humidify the test gas and sweep gas flows of the cells by two separate channels each equipped with an “EL-FLOW” gas mass flow controller (MFC) and an “μ-FLOW” liquid MFC (Bronkhorst High-Tech B. V.). The hydrogen gas (=test gas) is kept at 0% relative humidity, while the nitrogen gas (used as sweep gas) is kept at 50% relative humidity. High purity hydrogen and nitrogen gases are purchased from Messer Belgium NV. The High Purity Analyzer (HPA) detection system is composed of a TRACE 1300 GC (Thermo Fisher Scientific Inc.), which is expanded with a heated valve box. The H²TR of the multilayer structure was 10.2 cm³/m²·day·atm.

The multilayer structure after molding was subjected to a recycle test. The multilayer structure was pulverized by a pulverizer, and then charged in a 40 mmφ single screw extruder, and a extrusion test was performed under the conditions described below. For Examples 2 to 5, 10 and Reference examples 1 to 3 below, an extrusion test was performed under the same conditions.

Screw revolution: 95 rpm

Temperature setting of a cylinder and a die: C1/C2/C3/C4/C5/D=190° C./215° C./215° C./215° C./215° C./215° C.

Die hole number: 6 holes (3 mmφ)

The amount of die-lip deposition 30 min after initiation of extrusion was evaluated in accordance with the following criteria. The die-lip deposition is an indicator of recyclability. As a result, an evaluation class was A.
A: substantially no die-lip deposition
B: a small amount of die-lip deposition
C: a significant amount of die-lip deposition

As described above, the inside of the multilayer structure was kept in contact with the air at 20° C. and 0% RH while the outside was kept in contact with the air at 20° C. and 50% RH for 1 month, to adjust humidity. The multilayer structure was cut into a test piece with a size of 25 cm width and 25 cm length. This was mounted on a clamp frame with a height of 30 mm such that the outer side faced upward, and under the test condition of 23±2° C., a 500 g iron ball was dropped from 100 cm height, to give impact to the test piece, and no recesses or cracks were observed in the test piece.

Meanwhile, the multilayer structure after molding was subjected to a separate humidity-adjusting process. In the humidity-adjusting process, the inside of the multilayer structure was kept in contact with the air at 40° C. and 0% RH while the outside was kept in contact with the air at 40° C. and 90% RH for 4 months, to adjust humidity. A water content of the middle layer thus humidity-adjusted was measured by a Karl Fischer moisture meter, and a water content of the middle layer was 6.1 mass %. Using a test piece of the multilayer structure thus humidity-adjusted, an impact test was conducted as described above, and a recess was observed in the test piece.

### Reference Examples 1 and 2

The same procedure as described in Example 1 is repeated, except with different HDPE layer thicknesses, thereby altering the position and relative humidity of the EVOH layer in the multilayer sheet structure. The results and layer thicknesses are summarized in Table 1. For practical purposes, the permeation result reported for Reference example 2 is measured using the multilayer sheet in Example 1 in opposite orientation.

### Example 2

The same procedure as described in Example 1 is repeated, except the EVOH is replaced with an EVOH grade with lower ethylene content:

EVOH-27: Ethylene-vinyl alcohol copolymer with 27 mol % ethylene content, degree of saponification: 99.9 mol %, melt index: 4.0 g/10 min (at 210° C., 2.16 kg load), density: 1.21 g/cm³. The EVOH contains 100 ppm of acetic acid, 40 ppm of phosphate ion, 150 ppm of sodium ion and 180 ppm (in terms of boron atom) of boric acid.

The multilayer structure was humidity-adjusted by keeping the inside of the multilayer structure in contact with the air at 20° C. and 0% RH while keeping the outside in contact with the air at 20° C. and 50% RH for 1 month. The multilayer structure was cut into a test piece with a size of 25 cm width and 25 cm length. This was mounted on a clamp frame with a height of 30 mm such that the outer side faced upward, and under the test condition of 23±2° C., a 1000 g iron ball was dropped from 100 cm height, to give impact to the test piece, and a recess was observed in the test piece.

### Example 3

The same procedure as described in Example 1 is repeated, except the EVOH is replaced with an impact modified 27 mol % ethylene EVOH grade.

EVOH-27: same EVOH used in Example 2.

Elastomer: Maleic Anhydride modified α-olefin co-polymer “TAFMER MH7010” Mitsui Chemicals Europe GmbH; melt index: 0.9 g/10 min (at 190° C., 2.16 kg load), density 0.870 g/cm³.

EVOH-27-Elastomer: melt blend of 90 wt % EVOH-27 and 10 wt % Elastomer.

The multilayer structure was humidity-adjusted by keeping the inside in contact with the air at 20° C. and 0% RH while keeping the outside in contact with the air at 20° C. and 50% RH for 1 month. The multilayer structure was cut into a test piece, to which impact was given as described in Example 2. No recesses or cracks were observed in the test piece. This shows that the multilayer structure of Example 3 exhibited higher impact resistance than the multilayer structure of Example 2.

### Example 4

The same procedure as described in Example 1 is repeated, except the EVOH is replaced by an EVOH grade with lower ethylene content.

EVOH-24: Ethylene-vinyl alcohol copolymer with 24 mol % ethylene content, degree of saponification: 99.9 mol %, melt index: 2.2 g/10 min (at 210° C., 2.16 kg load), density: 1.22 g/cm³. The EVOH contains 100 ppm of acetic acid, 40 ppm of phosphate ion, 150 ppm of sodium ion and 180 ppm (in terms of boron atom) of boric acid.

### Example 5 and Reference Example 3

The same procedure as described in Example 1 is repeated, except the HDPE is replaced with Thermoplastic Polyurethane (TPU) resin layers. Since direct adhesion can be achieved between EVOH and the chosen TPU resin, no intermediate adhesive resin layers are required.

TPU: Lubrizol “ESTANE” TS 92AP7 NAT 055 from The Lubrizol Corporation, with a density of 1.20 g/cm³.

The test results and layer thicknesses are summarized in Table 1.

### Example 6 and Reference Example 4

The same procedure as described in Example 1 is repeated, except the HDPE and adhesive resin layers are replaced by polyamide 6 (nylon-6, PA6) and polyamide 6/12 (nylon 6/12, PA6.12). Since direct adhesion can be achieved between EVOH and the chosen polyamides, no additional adhesive resin layers are required.

PA6: UBE Nylon 1018SE from UBE Industries Ltd., melt index: 9 g/10 min (at 235° C., 2.16 kg load), density: 1.14 g/cm³.

PA6.12: “Chemlon 890 H” from Teknor Apex

The test results and layer thicknesses are summarized in Table 1.

The multilayer structure after molding was subjected to a recycle test. The multilayer structure was pulverized by a pulverizer, and then charged in a 40 mmφ single screw extruder, and a extrusion test was performed under the conditions described below. For Examples 7 to 10 and Reference examples 5 to 7 below, an extrusion test was performed under the same conditions.

Screw revolution: 95 rpm

Temperature setting of a cylinder and a die: C1/C2/C3/C4/C5/D=190° C./230° C./230° C./230° C./230° C./230° C.

Die hole number: 6 holes (3 mmφ)

The multilayer structure obtained in Example 6 was humidity-adjusted by keeping the inside of the multilayer structure in contact with the air at 20° C. and 0% RH while keeping the outside in contact with the air at 20° C. and 50% RH for 1 month. The multilayer structure was cut into a test piece with a size of 25 cm width and 25 cm length. This was mounted on a clamp frame with a height of 30 mm such that the outer side faced upward, and under the test condition of 23±2° C., a 1000 g iron ball was dropped 3 times from 100 cm height, to give impact to the test piece, and a recess was observed in the test piece.

### Example 7 and Reference Example 5

The same procedure as described in Example 1 is repeated, except the HDPE and adhesive resin layers are replaced with polyamide 6 (nylon-6, PA6) and polyamide 12 (nylon-12, PA12) layers. Since there is insufficient direct adhesion between EVOH and PA12, an additional PA6.12 and PA6 based layer (PA-Adh) is placed between the EVOH and PA12 layer.

PA-Adh: “Vestamid SX8002” a plasticized and impact modified extrusion molding composition based on PA6.12 and PA6 from EVONIK Resource Efficiency GmbH.

PA12: Polyamide 12 “UBESTA 3030XA” from UBE Industries Ltd., melt index: 2.0 g/10 min (at 235°° C., 2.16 kg load), density: 1.02 g/cm³. The test results and layer thicknesses are summarized in Table 1.

### Example 8 and Reference Example 6

The same procedure as described in Example 1 is repeated, except the HDPE and adhesive resin layers are replaced with polyamide 6 (nylon-6, PA6) on one side of the EVOH layer and a compounded blend of polyamide 6 and an elastomer (PA6-Elastomer) on the other side.

PA6: UBE Nylon 1018SE from UBE Industries Ltd., melt index: 9 g/10 min (at 235° C., 2.16 kg load), density: 1.14 g/cm³.

Elastomer: Maleic anhydride modified α-olefin co-polymer “TAFMER MH7010” commercially available from Mitsui Chemicals Europe GmbH, melt index: 0.9 g/10 min (at 190° C., 2.16 kg load), density 0.870 g/cm³.

PA6-Elastomer: melt blend of 80 wt % PA6 and 20 wt % Elastomer

The test results and layer thicknesses are summarized in Table 1.

The multilayer structure obtained in Example 8 was humidity-adjusted by keeping the inside in contact with the air at 20° C. and 0% RH while keeping the outside in contact with the air at 20° C. and 50% RH for 1 month. The multilayer structure was cut into a test piece, to which impact was given as described in Example 6. No recesses or cracks were observed in the test piece. This shows that the multilayer structure of Example 8 exhibited 20 higher impact resistance than the multilayer structure of Example 6.

### Example 9 and Comparative Example 7

The same procedure as described in Example 1 is repeated, except on the inside or outside of the EVOH the HDPE and adhesive resin layers are replaced by polyamide 6 (PA6).

### Example 10

A multilayer sheet was produced and evaluated as described in Example 1, except that in Example 9, the thicknesses of the outer and the inner layers were changed as described in Table 1.

### Example 11

A multilayer sheet was produced and evaluated as described in Example 1, substituting EVOH-32′ which was identical to EVOH-32 except that boric acid was absent, for EVOH-32. The multilayer structure obtained in Example 11 was humidity-adjusted by keeping the inside in contact with the air at 20° C. and 0% RH while keeping the outside in contact with the air at 20° C. and 50% RH, and was evaluated for impact resistance as described in Example 1, and a recess was observed in the test piece. In contrast, in Example 1, no recesses or cracks were observed in the test piece. Therefore, it was confirmed that excellent impact resistance was exhibited in Example 1 which contains boric acid.

TABLE 1

| | | | | | | Thickness | | | |
|---|---|---|---|---|---|---|---|---|---|
| | Material | | | | | (μm) | | | |
| No. | Outer | Bond | EVOH | Bond | Inner | Outer | Bond | EVOH | Bond |

Inner/outer layer of the same chemical composition, with bonding layers

| | | | | | | | | | |
|---|---|---|---|---|---|---|---|---|---|
| ex-1 | HDPE | Adh | EVOH-32 | Adh | HDPE | 100 | 50 | 100 | 50 |
| ref-1 | HDPE | Adh | EVOH-32 | Adh | HDPE | 400 | 50 | 100 | 50 |
| ref-2 | HDPE | Adh | EVOH-32 | Adh | HDPE | 700 | 50 | 100 | 50 |
| ex-2 | HDPE | Adh | EVOH-27 | Adh | HDPE | 100 | 50 | 100 | 50 |
| ex-3 | HDPE | Adh | EVOH-27- | Adh | HDPE | 100 | 50 | 100 | 50 |
| | | | Elastomer | | | | | | |
| ex-4 | HDPE | Adh | EVOH-24 | Adh | HDPE | 100 | 50 | 100 | 50 |
| ex-11 | HDPE | Adh | EVOH-32′ | Adh | HDPE | 100 | 50 | 100 | 50 |

Inner/outer layer of the same chemical composition, without bonding layers

| | | | | | | | | | |
|---|---|---|---|---|---|---|---|---|---|
| ex-5 | TPU | — | EVOH-32 | — | TPU | 150 | — | 100 | — |
| ref-3 | TPU | — | EVOH-32 | — | TPU | 750 | — | 100 | — |

Inner/outer layer of different chemical composition, with or without bonding layer

| | | | | | | | | | |
|---|---|---|---|---|---|---|---|---|---|
| ex-6 | PA6 | — | EVOH-32 | — | PA6/12 | 450 | — | 100 | — |
| ref-4 | PA6/12 | — | EVOH-32 | — | PA6 | 450 | — | 100 | — |
| ex-7 | PA6 | — | EVOH-32 | PA-Adh | PA12 | 450 | — | 100 | 100 |
| ref-5 | PA12 | PA-Adh | EVOH-32 | — | PA6 | 350 | 100 | 100 | — |
| ex-8 | PA6 | — | EVOH-32 | — | PA6- | 450 | — | 100 | — |
| | | | | | Elastomer | | | | |
| ref-6 | PA6 | — | EVOH-32 | — | PA6 | 450 | — | 100 | — |
| | Elastomer | | | | | | | | |
| ex-9 | PA6 | — | EVOH-32 | Adh | HDPE | 450 | — | 100 | 50 |
| ref-7 | HDPE | Adh | EVOH-32 | — | PA6 | 400 | 50 | 100 | — |
| ex-10 | PA6 | — | EVOH-32 | Adh | HDPE | 250 | — | 100 | 50 |

| | | | | WVTR | Water | | |
|---|---|---|---|---|---|---|---|
| | Thickness | WVTR | | ratio | content | H₂TR | Recyclability |
| | (μm) | (g/m² · day) | | Outer/ | of EVOH | (cm³/ | (die-lip |
| No. | Inner | Outer | Inner | Inner | (%) | m² · day · atm) | deposition) |
| | Inner/outer layer of the same chemical composition, with bonding layers | | | | | | |
| ex-1 | 700 | 1.1 | 0.16 | 6.9 | 1.4 | 10.2 | A |
| ref-1 | 400 | 0.28 | 0.28 | 1.0 | 0.7 | 11.3 | A |
| ref-2 | 100 | 0.16 | 1.1 | 0.1 | 0.3 | 13.0 | A |
| ex-2 | 700 | 1.1 | 0.16 | 6.9 | 1.5 | 6.5 | A |
| ex-3 | 700 | 1.1 | 0.16 | 6.9 | 1.4 | 15.2 | A |
| ex-4 | 700 | 1.1 | 0.16 | 6.9 | 1.4 | 3.7 | A |
| ex-11 | 700 | 1.1 | 0.16 | 6.9 | 1.3 | 10.4 | A |
| | Inner/outer layer of the same chemical composition, without bonding layers | | | | | | |
| ex-5 | 750 | 142 | 28.3 | 5.0 | 1.3 | 10.1 | B |
| ref-3 | 150 | 28.3 | 142 | 0.2 | 0.3 | 12.9 | B |
| | Inner/outer layer of different chemical composition, with or without bonding layer | | | | | | |
| ex-6 | 450 | 8.3 | 7.1 | 1.2 | 1.6 | 11.1 | C |
| ref-4 | 450 | 7.1 | 8.3 | 0.9 | 1.0 | 11.7 | C |
| ex-7 | 350 | 8.3 | 4.3 | 1.9 | 1.5 | 10.4 | C |
| ref-5 | 450 | 4.3 | 8.3 | 0.5 | 0.7 | 12.2 | C |
| ex-8 | 450 | 8.3 | 3.8 | 2.2 | 1.2 | 10.4 | C |
| ref-6 | 450 | 3.8 | 8.3 | 0.5 | 0.9 | 12.8 | C |
| ex-9 | 400 | 8.3 | 0.28 | 29.6 | 2.3 | 9.6 | C |
| ref-7 | 450 | 0.28 | 8.3 | 0.03 | 0.2 | 13.8 | C |
| ex-10 | 600 | 15 | 0.18 | 83.3 | 2.5 | 9.4 | C |

1. A multilayer structure for storing or transporting a gas comprising hydrogen, wherein the multilayer structure comprises at least three layers comprising
a. an inner layer comprising at least one first polymer,
b. a middle layer comprising ethylene-vinyl alcohol copolymer, and
c. an outer layer comprising at least one second polymer,
and wherein the water-vapour transmission rate measured at 38° C. and 90% RH according to ISO15106-2:2003 of the inner layer is lower than the water-vapour transmission rate measured at 38° C. and 90% RH according to ISO15106-2:2003 of the outer layer.

2. The multilayer structure according to claim 1, wherein a ratio (I/O) is 60/40 or more and 99/1 or less, wherein I is the total thickness of the layers positioned inside the middle layer and O is the total thickness of the layers positioned outside the middle layer.

3. The multilayer structure according to claim 1, wherein a ratio (A/B) is 3/97 or more and 30/70 or less, wherein A is the thickness of the middle layer and B is the thickness of the multilayer structure.

4. The multilayer structure according to claim 1, wherein the first polymer and the second polymer have the same chemical composition and wherein the thickness of the inner layer is higher than the thickness of the outer layer.

5. The multilayer structure according to claim 1, wherein the first polymer is high-density polyethylene (HDPE).

6. The multilayer structure according to claim 5, wherein both of the first polymer and the second polymer are high-density polyethylene (HDPE), and a ratio (I/O) is 60/40 or more and 99/1 or less, wherein I is the total thickness of the layers positioned inside the middle layer and O is the total thickness of the layers positioned outside the middle layer.

7. The multilayer structure according to claim 1, wherein the second polymer is polyamide (PA).

8. The multilayer structure according to claim 7, wherein the first polymer is high-density polyethylene (HDPE) and the second polymer is polyamide (PA), and a ratio (I/O) is 60/40 or more and 99/1 or less, wherein I is the total thickness of the layers positioned inside the middle layer and O is the total thickness of the layers positioned outside the middle layer.

9. The multilayer structure according to claim 1, wherein an ethylene content of the ethylene-vinyl alcohol copolymer is between 20 and 60 mol %.

10. The multilayer structure according to claim 9, wherein an ethylene content of the ethylene-vinyl alcohol copolymer is 20 mol % or more and 30 mol % or less.

11. The multilayer structure according to claim 1, wherein the middle layer comprises 5 ppm or more and 200 ppm or less of a phosphate ion and 10 ppm or more and 400 ppm or less of an alkali metal ion.

12. The multilayer structure according to claim 1, wherein the middle layer comprises 50 ppm or more and 400 ppm or less, in terms of boron element, of a boron compound.

13. The multilayer structure according to claim 1, wherein the middle layer further comprises at least one additional polymer chosen from the list consisting of elastomers, polyolefins, polyesters, polyurethanes and polyamide.

14. The multilayer structure according to claim 13, wherein the middle layer comprises 70 mass % or more and 99 mass % or less of ethylene-vinyl alcohol copolymer and 1 mass % or more and 30 mass % or less of acid-modified ethylene-α-olefin copolymer.

15. The multilayer structure according to claim 1, wherein a water content of the middle layer is 1.1 mass % or more and 4 mass % or less.

16. The multilayer structure according to claim 1, wherein the gas comprises equal to or more than 99 vol % hydrogen.

17. The multilayer structure according to claim 1, wherein a relative humidity of the gas is 20% or less.

18. A hydrogen storage vessel or a hydrogen transportation pipe comprising or consisting of the multilayer structure according to claim 1.

19. A hydrogen storage vessel according to claim 18, wherein the first polymer is high-density polyethylene (HDPE) and the second polymer is high-density polyethylene (HDPE) or polyamide (PA), and a ratio (I/O) is 60/40 or more and 99/1 or less, wherein I is the total thickness of the layers positioned inside the middle layer and O is the total thickness of the layers positioned outside the middle layer.

20. A hydrogen storage vessel according to claim 18, wherein the first polymer is high-density polyethylene (HDPE) and the second polymer is polyamide (PA), and a ratio (A/B) is 3/97 or more and 30/70 or less, wherein A is the thickness of the middle layer and B is the thickness of the multilayer structure.

21. A hydrogen transportation pipe according to claim 18, wherein the first polymer is high-density polyethylene (HDPE) and the second polymer is high-density polyethylene (HDPE) or polyamide (PA), and a ratio (I/O) is 60/40 or more and 99/1 or less, wherein I is the total thickness of the layers positioned inside the middle layer and O is the total thickness of the layers positioned outside the middle layer, and a relative humidity of the gas is 20% or less.

22. A hydrogen transportation pipe according to claim 18, wherein the first polymer is high-density polyethylene (HDPE) and the second polymer is polyamide (PA), and a relative humidity of the gas is 20% or less.

23. Use of the multilayer structure according to claim 1 in a hydrogen storage tank, a liner for a hydrogen storage tank, a hydrogen transportation pipe or a liner for a hydrogen transportation pipe.

24. The use according to claim 23, wherein before storage or transportation of hydrogen gas, the multilayer structure is aged in a high relative humidity environment, to adjust a water content of the middle layer to 1.1 mass % or more and 4 mass % or less.

25. The use according to claim 23, wherein the multilayer structure is used in a motor vehicle.

26. A fuel cell electric vehicle (FCEV) comprising the multilayer structure according to claim 1.
